(19) United States
(12) Patent Application Publication
(10) Pub. No.: US 2023/0342924 A1
(43) Pub. Date: Oct. 26, 2023

(54) SYSTEM AND METHOD FOR CLASSIFYING IMAGES USING CONTRAPOSITIVE MACHINE LEARNING

(71) Applicant: 2692873 Ontario Inc., Toronto (CA)

(72) Inventor: Trevor CHAMPAGNE, Kamloops (CA)

(21) Appl. No.: 18/138,688

(22) Filed: Apr. 24, 2023

Related U.S. Application Data
(60) Provisional application No. 63/334,248, filed on Apr. 25, 2022.

(51) Int. Cl. G06T 7/00; G06V 10/764; G06V 10/82; G06T 7/155; G06V 10/774; G06V 20/70

(52) U.S. Cl. CPC G06T 7/0012; G06V 10/764; G06V 10/82; G06T 7/155; G06V 10/774; G06V 20/70; G06V 2201/03; G06T 2207/30088; G06T 2207/20021; G06T 2207/20036; G06T 2207/20084; G06V 20/41

(57) ABSTRACT

Systems and methods using machine learning for classifying samples, for example medical images such as dermatological images. The method can use contrapositive logic principals. An example of the method includes: receiving a sample; generating, by a first neural network using the sample: a first classification of a positive label versus a negative label; generating, by a second neural network using the sample: a second classification of the negative label versus not the negative label; and generating, by a category classification module using the first classification and the second classification: a category of the sample.

### CROSS-REFERENCE

This application claims the benefit of priority to U.S. Provisional Patent Application No. 63/334,248 filed Apr. 25, 2022 entitled SYSTEM AND METHOD FOR CLASSIFYING IMAGES USING CONTRAPOSITIVE MACHINE LEARNING, the entire contents of which are incorporated by reference into the Detailed Description herein below.

### TECHNICAL FIELD

Example embodiments generally relate to the field of classifying samples, such as medical images.

### BACKGROUND

A machine learning model can be trained using to a dataset including a set of labelled samples, where each sample associated with a label indicates some information about the sample, then the machine learning model system can learn from the set of labelled samples and apply. Once the machine learning model is trained properly, what the machine learning model has learned can be used to make a prediction when given a new set of unlabelled samples.

In dermatology diagnoses, each sample may be a dermatological image, such as a photograph. Binary classification may be used to classify a dermatological image into two categories. For examples, a trained machine learning model may report “skin cancer” or “not skin cancer”. In some examples, there may be sparse data samples for a positive classification and a larger number of data samples for a negative classification. Such a scenario may arise, for example, for smaller genetic subsets of the population and/or for rare conditions. Some machine learning models are not effective when trained on a small number of data samples.

However, in medical treatments or diagnosis, uncertainty may cause danger to patients. Thus, it is desirable to provide improved prediction results in medical decision making scenarios by using a machine learning model.

It may be desired to have greater certainty using a machine learning model.

It may be desired to train a machine learning model using sparse datasets.

It may be desired to identify samples as being ambiguous or outside of a distribution.

### SUMMARY

Systems and methods using machine learning for classifying samples, for example medical images such as dermatological images. The method can use contrapositive logic principals, for example samples may have a positive label and a negative label. Samples that are not the negative label can reliably or probabilistically be considered the positive label.

An example embodiment is a method of classifying, including: receiving a sample; generating, by a first neural network using the sample: a first classification of a positive label versus a negative label; generating, by a second neural network using the sample: a second classification of the negative label versus not the negative label; and generating, by a category classification module using the first classification and the second classification: a category of the sample.

An advantage of the method is that the category uses the classification by two neural networks based on contrapositive logic principals, improving robustness.

An advantage of the method is that the method can identify samples as being ambiguous or outside of a distribution

In an example embodiment of any of the above, when the first classification is the positive label and the second classification is not the negative label, the category of the sample by the category classification module is the positive label.

In an example embodiment of any of the above, when the first classification is the negative label and the second classification is the negative label, the category of the sample by the category classification module is the negative label.

In an example embodiment of any of the above, when the first classification is the negative label and the second classification is not the negative label, the category of the sample by the category classification module is outside a distribution.

In an example embodiment of any of the above, when the first classification is the positive label and the second classification is the negative label, the category of the sample by the category classification module is ambiguous.

In an example embodiment of any of the above, the method further includes the first neural network generating a first classification score of the positive label versus the negative label, and the second neural network generating a second classification score of the negative label versus the not the negative label.

In an example embodiment of any of the above, the generating the category includes the category classification module determining that the first classification score is a probability complement to the second classification score, or within a threshold.

In an example embodiment of any of the above, the first neural network and the second neural network are in parallel.

In an example embodiment of any of the above, the category classification module is rules based.

In an example embodiment of any of the above, the category classification module is a machine learning model.

In an example embodiment of any of the above, the first neural network and the second neural network each comprise at least one of: a support vector machine (SVM), linear regression, or a convolutional neural network (CNN).

In an example embodiment of any of the above, the sample includes a medical image.

In an example embodiment of any of the above, the medical image is a dermatological image.

In an example embodiment of any of the above, the positive label is a diagnosis, a likely diagnosis, suitability for diagnosis, testing being required, or a recommended treatment.

In an example embodiment of any of the above, the method further includes performing, by a machine learning model, segmentation of the sample to identify morphological segments in the sample, wherein the category is generated for at least one of the morphological segments.

In an example embodiment of any of the above, the category is generated for all of the morphological segments.

In an example embodiment of any of the above, the method is performed by a processing device.

In an example embodiment of any of the above, the method further includes receiving the sample from a video conference software application.

Another example embodiment is a method for a machine learning model including a first neural network and a second neural network, the method including: receiving a dataset comprising a first set of samples each having a positive label and a second set of samples each having a negative label; training the first neural network using the first set of samples and the second set of samples to perform a first classification of the positive label versus the negative label; training the second neural network using the first set of samples and the second set of samples to perform a second classification of the negative label versus not the negative label; and providing a category classification module which is configured to generate a category using the first classification and the second classification.

An advantage of the method is that the two neural networks of the machine learning model are trained based on contrapositive logic principals, improving robustness.

An advantage of the method is that the machine learning model can be trained using sparse datasets in which the number of samples having the positive label are much fewer than the number of samples having the negative label, such as rare diseases or low genetic populations.

In an example embodiment of any of the above, when the first classification is the positive label and the second classification is not the negative label, the category classification module is configured to generate the category as being the positive label.

In an example embodiment of any of the above, when the first classification is the negative label and the second classification is the negative label, the category classification module is configured to generate the category as being the negative label.

In an example embodiment of any of the above, when the first classification is the negative label and the second classification is not the negative label, the category classification module is configured to generate the category as being outside a distribution.

In an example embodiment of any of the above, when the first classification is the positive label and the second classification is the negative label, the category classification module is configured to generate the category as being ambiguous.

In an example embodiment of any of the above, the first neural network is configured to generate a first classification score of the positive label versus the negative label, and the second neural network is configured to generate a second classification score of the negative label versus the not the negative label.

In an example embodiment of any of the above, the category classification module is configured to generate the category by determining that the first classification score is a probability complement to the second classification score, or within a threshold.

In an example embodiment of any of the above, the first neural network and the second neural network are in parallel.

In an example embodiment of any of the above, a first number of the first set of samples is at least ten times less than a second number of the second set of samples.

In an example embodiment of any of the above, the category classification module is rules based.

In an example embodiment of any of the above, the method further includes training the category classification module to generate the category using the first classification and the second classification.

In an example embodiment of any of the above, the machine learning model comprises at least one of: a support vector machine (SVM), linear regression, or a convolutional neural network (CNN).

In an example embodiment of any of the above, the dataset includes medical images.

In an example embodiment of any of the above, the medical images are dermatological images.

In an example embodiment of any of the above, each of the dermatological images are labelled with a diagnosis, a likely diagnosis, suitability for diagnosis, testing being required, or a recommended treatment.

In an example embodiment of any of the above, the method further includes: training the machine learning model to perform segmentation to identify morphological segments, wherein the category classification module is configured to generate the category of at least one of the morphological segments.

In an example embodiment of any of the above, the category classification module is configured to generate the category of all of the morphological segments.

In an example embodiment of any of the above, the method is performed by a processing device.

Another example embodiment is a system for training a machine learning model including a first neural network and a second neural network, the system including: a processing device; and a memory accessible by the processing device, the memory storing machine-executable instructions that, when executed by the processing device, cause the processing device to: receive a dataset comprising a first set of samples each having a positive label and a second set of samples each having a negative label; train the first neural network using the first set of samples and the second set of samples to perform a first classification of the positive label versus the negative label; train the second neural network using the first set of samples and the second set of samples to perform a second classification of the negative label versus not the negative label; and provide a category classification module which is configured to generate a category using the first classification and the second classification.

Another example embodiment is a non-transient computer readable medium containing instructions for causing a processing device to perform a method for a machine learning model including a first neural network and a second neural network, the instructions including: instructions for receiving a dataset comprising a first set of samples each having a positive label and a second set of samples each having a negative label; instructions for training the first neural network using the first set of samples and the second set of samples to perform a first classification of the positive label versus the negative label; instructions for training the second neural network using the first set of samples and the second set of samples to perform a second classification of the negative label versus not the negative label; and instructions for providing a category classification module which is configured to generate a category using the first classification and the second classification.

Another example embodiment is a system for classifying, the system comprising: a processing device; and a memory accessible by the processing device, the memory storing machine-executable instructions that, when executed by the processing device, cause the processing device to: receive a sample; generate, by a first neural network using the sample: a first classification of a positive label versus a negative label; generate, by a second neural network using the sample: a second classification of the negative label versus not the negative label; and generate, by a category classification module using the first classification and the second classification: a category of the sample.

Another example embodiment is a non-transient computer readable medium containing instructions for causing a processing device to perform a method, the instructions including: instructions for receiving a sample; instructions for generating, by a first neural network using the sample: a first classification of a positive label versus a negative label; instructions for generating, by a second neural network using the sample: a second classification of the negative label versus not the negative label; and instructions for using the first classification and the second classification to generate a category of the sample.

Another example embodiment is a system including: a processing device; and a memory accessible by the processing device, the memory storing machine-executable instructions that, when executed by the processing device, cause the processing device to perform any one of the above described methods.

Another example embodiment is a non-transient computer readable medium containing instructions for causing a processing device to perform a method, the instructions including instructions for performing any one of the above described methods.

### BRIEF DESCRIPTION OF THE FIGURES

The features and advantages of example embodiments will become apparent from the following detailed description, taken in combination with the appended drawings, in which:

FIG. 1 shows a flow diagram illustrating an example process for training a machine learning model, in accordance with an example embodiment;

FIG. 2 shows a schematic diagram illustrating the example machine learning model being trained in the example process of FIG. 1, in accordance with an example embodiment;

FIG. 3 shows a flow diagram illustrating an inference process performed by the machine learning model;

FIG. 4 shows a schematic diagram illustrating the example machine learning model for performing the inference process of FIG. 3, in accordance with an example embodiment;

FIG. 5 shows an example of segmentation for the inference process performed by the machine learning model of FIG. 4;

FIG. 6 illustrates an example schematic diagram showing a processing system for training and/or inference using an example machine learning model, in accordance with an example embodiment; and

FIG. 7 shows an example embodiment of a neural network of the machine learning model of FIG. 4.

It is to be understood that throughout the appended drawings and corresponding descriptions, like features may be identified by like reference characters. Furthermore, it is also to be understood that the drawings and ensuing descriptions are intended for illustrative purposes only and that such drawings and descriptions are not intended to be limiting.

### DETAILED DESCRIPTION

Various representative example embodiments will be described more fully hereinafter with reference to the accompanying drawings. Example embodiments may, however, be embodied in many different forms and should not be construed as limited to the representative embodiments set forth herein. In the drawings, the sizes and relative sizes of layers and regions may be exaggerated for clarity. Like numerals may refer to like elements throughout.

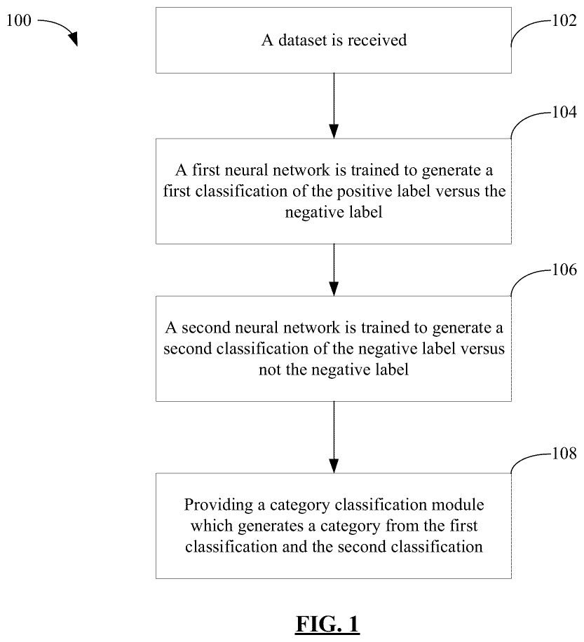

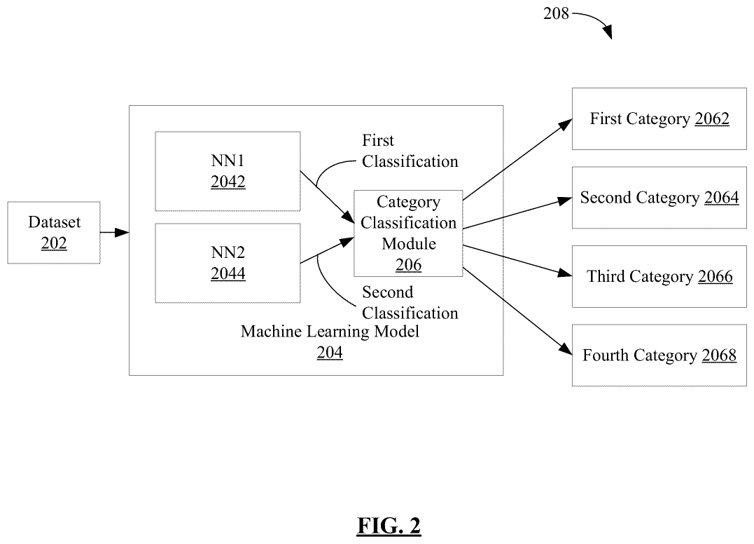

Example embodiments relate to systems and methods to train and implement a machine learning model. FIG. 1 illustrates an example schematic diagram showing a method 100 for training a machine learning model 204 (FIG. 2), in accordance with an example embodiment. The method 100 includes, at step 102, a dataset is received by the machine learning model. FIG. 2 illustrates how to use a dataset 202 to generate a category 208 which can be one of a plurality of categories 208 by training the machine learning model 204. The machine learning model 204 includes a first neural network (NN) (denoted as NN1) 2042 and a second neural network (denoted as NN2) 2044. In some applications, the first NN 2042 and the second NN 2044 are in parallel. The category classification module 206 receives a first classification generated by the first NN 2042 and a second classification generated by the second NN 2044. The category classification module 206 generates a category 208 (classification) from the first classification and the second classification. In some embodiments, the machine learning model 204 comprises at least one of: a support vector machine (SVM), linear regression, or a convolutional neural network (CNN). For example, the first NN 2042 and the second NN 2044 can each include pooling layers, convolution layers, and/or other layers.

The dataset 202 comprises a first set of samples and a second set of samples. Each of the first set of samples includes a positive label, and each of the second set of samples includes a negative label. The positive label and the negative label are logical negations. For example, the dataset 202 is a dataset of medical images such as dermatological images. The first set of samples also have the label (or defacto label) “not the negative label”. Each positive label may include a label denoted “A” (e.g. “rosacea”), and each negative label may be denoted by “B” (e.g. “not rosacea”). In such an example, the first set of samples also have the label (or defacto label) “not B”. This is an example and not intended for limiting. Other labels may be used in other examples. In an example, these labels are binary values in that there are two mutually exclusive labels. In some other examples, the dataset may have the samples with one or more labels, which can include a diagnosis (or likely diagnosis), a treatment, and/or patient information, with a negative label meaning a contrary or negation of those labels. For example, each positive label may include “use steroid”, and each negative label may include “do not use steroid”. In such an example, the samples in the dataset with the positive label also has the label (or defacto label) as “do not not use steroid”.

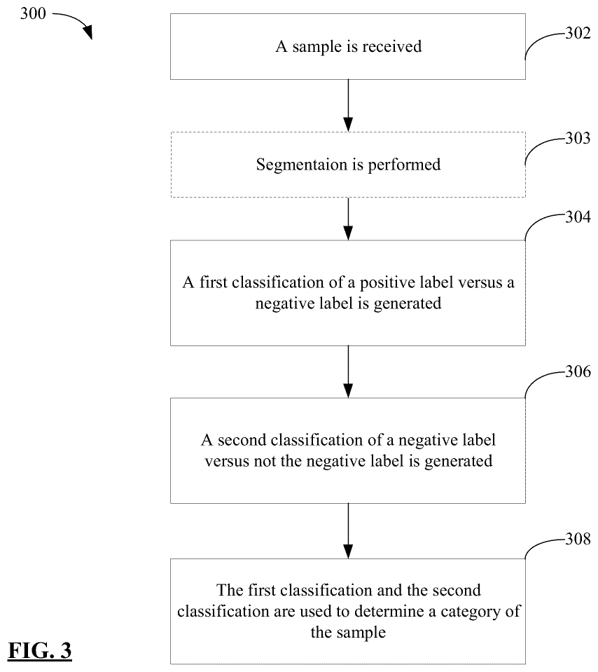

In an example, the labelled images are identified with morphological segments (e.g. using outlines or image masks), and a respective particular positive label versus negative label is identified for at least one or all of the morphological segments. Such labelled images can be used for training of a segmentation module (not shown here) of the machine learning model 204 as illustrated in FIGS. 3, 4 and 5.

In some examples, the number of samples in the second set is approximately the same as the number of samples in the first set, or at least within an order of magnitude. In some examples, the number of samples in the second set is greater than the number of the first set, for example in cases where there is limited or sparse data for the positive label. Such a scenario can arise, for example, for smaller genetic subsets of the population and/or for rare conditions. In some examples, the number of samples in the second set is at least ten times greater, or at least one hundred times greater, or at least one thousand times greater, than the number of samples in the first set.

An example of a first set having smaller curated distributions is aboriginal/indigenous skin. In such an example, the first set includes samples having indigenous skin labelled with the condition (positive label), and the second set includes samples having indigenous skin labelled without the condition (negative label). In such an example, the positive label also has the label (or defacto label) as “not without the condition”.

Another example way to classify a medical image in the dataset 202 is whether the medical image is good for diagnosis, in the opinion of one or more medical professionals such as a clinician or a dermatologist: is the given image a “good quality” (i.e., good enough to make a diagnosis) or “bad quality” (i.e., not good enough to make a diagnosis)? A positive label can be “good quality”, and a negative label can be “bad quality”. In such an example, the positive label also has the label (or defacto label) as “not bad quality”. A consultation request should have at least one good quality image for the purpose of determining the morphology of a skin eruption. Clinical image quality has also emerged as a concern for the longevity and cost-effectiveness of teledermatology. If the medical image is of insufficient quality, then clinician time is wasted in reviewing a bad quality image. Another image would then need to be retaken to replace the bad quality image with a good quality image, so that the good quality image can be further reviewed by the clinician. As well, bandwidth is wasted in transmitting the bad quality image to the clinician for review, even more so when the image is uncompressed.

In examples, the labels in the dataset 202 can be generated by one or more professionals such as dermatologists. In examples, the labels in the dataset 202 can be generated by one or more machines or other machine learned models. In examples, the labels in the dataset 202 can be obtained from established libraries.

At step 104, the first NN 2042 is trained to generate a first classification of the positive label versus the negative label, by using the first set of samples and the second set of samples. In some examples, the first NN 2042 is trained to generate a first probability of the positive label versus the negative label. In an example, the first NN 2042 is trained to generate a first classification score of the positive label versus the negative label. For example, the first classification score can be generated from the first probability. For example, the first classification score may be 0.80, which indicates an input to the first NN 2042 has a higher probability to include the positive label versus to include the negative label. The first classification score can represent a first probability generated by the first NN 2042.

At step 106, the second NN 2044 is trained to generate a second classification of the negative label versus not the negative label, by using the first set of samples and the second set of samples. In some examples, the second NN 2044 is trained to generate a second probability of the negative label versus not the negative label. In an example, the second NN 2044 is trained to generate a second classification score of the negative label versus not the negative label. For example, the second classification score can be generated from the second probability. By way of example, the second classification score may be 0.20 (less than 0.50), which indicates an input sample to the second NN 2044 has a less probability to include the negative label versus not the negative label. The second NN 2044 relies upon a contrapositive logic principal, for example that samples that are not the negative label can reliably or probabilistically be the positive label.

Example modules that can be used by the first NN 2042 or the second NN 2044 for generating the first classification score from the first probability or the second classification score from the second probability include Sigmoid or Softmax, as understood in the art. The first NN 2042 can generate the first classification from the first classification score, e.g. using a threshold of 0.5. The second NN 2044 can generate the second classification from the second classification score, e.g. using the threshold of 0.5.

In examples, the threshold can be a value other than 0.5. For example, the threshold can be manually set or learned (trained). For example, the threshold can be fixed or dynamically generated by the machine learning model 204.

In an example, when the first NN 2042 and the second NN 2044 are being trained, the first NN 2042 and the second NN 2044 can be given an identical input with an identical sample from the dataset 202 (having the positive and negative labels). If and when the first NN 2042 and the second NN 2044 are being subsequently refined, a new dataset 202 can be used for refining both the first NN 2042 and the second NN 2044. In some examples, the second classification by the second NN 2044 relies on contrapositive logic, in which not being the negative label means the positive label (or at least there being a high probability of being the positive label). For example, a dermatological image (sample) can be input to the first NN 2042 and the second NN 2044, the first NN 2042 may be trained to identify the dermatological image with a first classification of the positive label “rosacea” (i.e., “A”) which may be represented by a first classification score (e.g., 0.80). The second NN 2044 may be performed to identify that the dermatological image has a second classification of “not not rosacea” (i.e., “not B”). The first classification score (e.g., 0.80) is generated to represent a first probability of the positive label “rosacea” vs the negative label “not rosacea”, and the second classification score (e.g., 0.20) is generated of the negative label “not rosacea” vs not the negative label “not not rosacea”. The first NN 2042 generates a first classification from the first classification score, for example greater than 0.5 of the first classification score means a first classification of the positive label, and less than 0.5 of the first classification score means a first classification of the negative label. The second NN 2044 generates a second classification from the second classification score, for example greater than 0.5 of the second classification score means a second classification of the negative label, and less than 0.5 of the second classification score means a second classification of not the negative label.

At step 108, the category classification module 206 is configured to generate a category 208 (or classification) from the first classification and the second classification. In some examples, the plurality of categories 208 includes a first category 2062, second category 2064, third category 2066, and fourth category 2068. In an example, the category classification module 206 is rules based. In another example, the category classification module 206 is part of the machine learning module 204 with parameters or weights that are learned during the method 100 for training the machine learning module 204. In an example, the first category 2062 is the positive label, the second category 2064 is the negative label, the third category 2066 is outside a distribution, and the fourth category 2068 is ambiguous.

For the first category 2062 (positive label), the category classification module 206 can determine that the first classification is the positive label and the second classification is the not the negative label.

For the first category 2062, the category classification module 206 can determine that the first classification score is greater than a threshold, e.g., 0.5, and the second classification score is less than the threshold, e.g. 0.5.

For example, when the first classification score is 0.80 positive label and the second classification score is 0.20 negative label, then the category classification module 206 determines that the sample is the first category 2062, e.g. positive label.

For the second category 2064 (negative label), the category classification module 206 can determine that the first classification is the negative label (not the positive label) and the second classification is the negative label.

For the second category 2064, the category classification module 206 can determine that the first classification score of the positive label is less than a threshold, e.g., 0.5, and the second classification score of the negative label is greater than the threshold, e.g. 0.5.

For example, when the first classification score is 0.20 positive label and the second classification score is 0.80 negative label, then the category classification module 206 determines that the sample is the second category 2064, e.g. negative label.

For the third category 2066 (outside a distribution), the category classification module 206 can determine that the first classification is the negative label (not the positive label) and the second classification is not the negative label.

For the third category 2066, the category classification module 206 can determine that the first classification score is less than a threshold, e.g., 0.5, and the second classification score is less than the threshold, e.g. 0.5.

For example, when the first classification score is 0.40 positive label and the second classification score is 0.40 negative label, then the category classification module 206 determines that the sample is the third category 2066, in which the sample is outside the distribution. “Outside the distribution” means the sample is neither associated with a feature of the positive label nor with a feature of the negative label. Thus, the third category 2066 is generated to classify samples outside the distribution. In the example where the sample is a dermatological image, the third category 2066 may classify the dermatological image as outside the distribution, meaning the sample is neither associated with the positive label “rosacea” nor with the negative label “not rosacea”.

For the fourth category 2068 (ambiguous), the category classification module 206 can determine that the first classification is the positive label and the second classification is the negative label.

For the fourth category 2068, the category classification module 206 can determine that the first classification score is greater than a threshold, e.g., 0.5, and the second classification score is greater than the threshold, e.g. 0.5.

For example, when the first classification score is 0.80 positive label and the second classification score is 0.80 negative label, then the category classification module 206 determines that the sample is the fourth category 2068, in which the sample is ambiguous. That means the sample was found by the machine learning model 204 to have a high probability of the positive label and a high probability of the negative label at the same time. However, as the positive label is in contrast to the negative label, it is inconsistent that the sample includes the positive label and negative label concurrently. Thus, the sample is considered to be ambiguous because the sample is associated with the positive label and the negative label at the same time. The fourth category 2068 is generated to define that a set of samples are ambiguous. In the example where the sample is a dermatological image, the sample is determined to be ambiguous because the image is associated both with the positive label “rosacea” and the negative label “not rosacea”.

As a further check, for the first category 2062, the category classification module 206 can further compare the first classification score (e.g. 0.8) and the second classification score (e.g. 0.2) for generating the category 208. For example, the category classification module 206 can determine (e.g. compute or calculate) whether the first classification score is a probability complement of the second classification score. In other words, whether the first classification score=1.0 minus the second classification score. In the present example, whether 0.8 is equal to 1.0 minus 0.2, which it is. In such an example, the category classification module 206 can categorize a sample as falling under the first category when this additional check is satisfied. In an example, the check of the probability complement can be within a threshold (e.g. within 0.1 or 0.01) and not exactly equivalent, in which the threshold can be manually set or learned. When the first classification score is a probability complement of the second classification score, the category classification module 206 can conclude that the sample falls in the third category 2066 or the fourth category 2068, as detailed above. Another example further check is to add the first classification score to the second classification score to see whether the sum is equal to a set value, such as 1.0 (or within a threshold).

In examples, similar types of further checks can be performed by the category classification module 206 for concluding that a sample should fall within the second category 2064 or does not fall within the second category 2064.

Once the machine learning model 204 is trained, the category 208 can be generated by the machine learning model 204 and the category classification module 206 in order to classify a sample that is input to the machine learning model 204 during inference. Therefore, a sample can be classified into one of the four categories 208. Such a machine learning model 204 may help to identify ambiguous samples of the fourth category 2068 (e.g., considered to be “ambiguous” because the samples are classified to be associated with the positive label and the negative label at the same time) and to identify samples that are outside a distribution of the third category 2066 (e.g., associated with neither the positive label nor the negative label). Thus, accuracy of classifying a sample may be improved significantly.

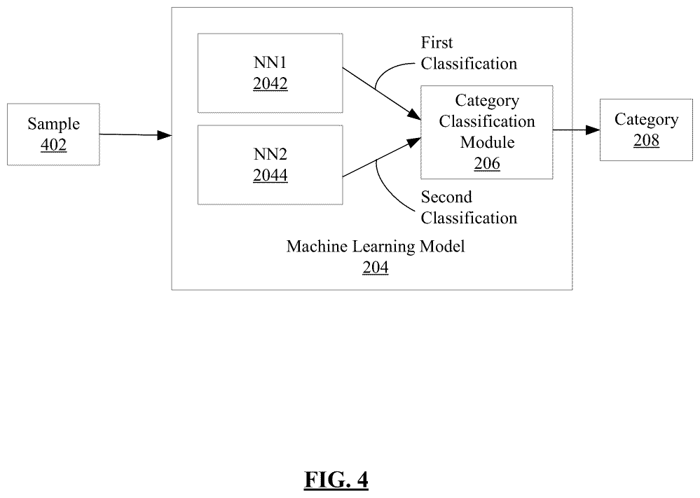

FIG. 3 illustrates a method 300 of classifying samples in accordance with an example embodiment. The method 300 of classifying the samples is a process of inference performed by the machine learning model 204 that has been trained. The method 300 includes, at step 302, a sample is received by the machine learning model 204. Once the machine learning model 204 has been trained, the machine learning model 204 may receive a sample and classify the sample. FIG. 4 shows a schematic diagram of classifying a sample 402 by the now-trained machine learning model 204.

In some examples, at step 303, segmentation is performed by a segmentation module (not shown here) of the machine learning model 204, which will be discussed in greater detail.

At step 304, a first classification of a positive label versus a negative label is generated by performing a first classification.

At step 306, a second classification of a negative label versus not the negative label is generated by performing a second classification.

As discussed above, the first classification may be generated from the first classification score which represents a probability of a positive label versus a negative label. The second classification may be generated from the second classification score which defines the negative label versus not the negative label.

At step 308, the first classification and the second classification are used by the category classification module 206 to determine (generate) a category 208 of the sample from the plurality of the categories 208. The generated first classification score and second classification score respectively generated from the first NN 2042 and the second NN 2044 can be used to determine which category 208 the sample 402 belongs.

For example, when the first classification is the positive label and the second classification is not the negative label, the category classification module 206 determines that the sample 402 is the first category 2062. In another example, if the first classification score is 0.80 positive label, and the second classification score is 0.20 negative label, the category classification module 206 determines that the sample 402 has a high probability to be associated with a positive label “rosacea”. Thus, the sample 402 is considered to belong to the first category 2062.

For example, when the first classification is the negative label (not the positive label) and the second classification is the negative label, the category classification module 206 determines that the sample 402 is the second category 2064. In another example, if the first classification score is 0.30, and the second classification score is 0.70, it is determined that the sample 402 has a high probability to be associated with a feature of a negative label “not rosacea”. In this case, the sample 402 is considered to belong to the second category 2064.

For example, when the first classification is the negative label (not the positive label) and the second classification is not the negative label, the category classification module 206 determines that the sample 402 is the third category 2066.

In another example, if the first classification score is 0.40 positive label, and the second classification score is 0.40 negative label, the sample 402 is considered to have a less probability to be associated with a feature of the positive label “rosacea” and to have a less probability to be associated with a feature of the negative label “not rosacea” because each of the first classification score and the second classification score is less than a predefined threshold (e.g., 0.50). Thus, it is determined that the sample 402 is outside the distribution. Therefore, the sample 402 is classified to belong to the third category 2066.

For example, when the first classification is the positive label and the second classification is the negative label, the category classification module 206 determines that the sample 402 is the fourth category 2068.

In another example, if the first classification score is 0.70 (greater than the threshold of 0.5), and the second classification score is 0.70 (greater than the threshold of 0.5), the sample 402 is determined to belong to the fourth category 2068. Because each of the first classification score and the second classification score is greater than the predefined score (e.g., 0.50), it is determined by the category classification module 206 to both have a higher probability to be associated with a feature of the positive label “rosacea” and to have a higher probability to be associated with a feature of the negative label “not rosacea” at the same time. Thus, it is determined by the category classification module 206 that the sample 402 is ambiguous because it is inconsistent that the sample is associated with the feature of the positive label “rosacea” and associated with the feature of the negative label “not rosacea” at the same time. As the sample 402 is determined to be ambiguous, the sample 402 may need a professional's additional attention to be re-evaluated. For example, after the sample 402 is determined to be an ambiguous dermatological image which is associated with the feature of the positive label “rosacea” and the feature of the positive label “not rosacea” at the same time, the dermatological image (sample 402) is then red-flagged. The red-flagged dermatological image (sample 402) may be re-evaluated by a physician or midlevel professional to determine features.

As the third category 2066 is generated and used to classify a sample, unpredictable classifications may be avoided because unpredictable samples which are out-of-distribution can be classified into the third category 2066 and can be added to the dataset 202 to retrain the machine learning model 204, which may help to improve accuracy of training the machine learning model 204 and classifying the out-of-distribution samples significantly. In addition, uncertain samples can be classified into the fourth category 2068, which will be re-evaluated again. Thus, accuracy of classification has been improved significantly. Such solution may be applied in underrepresented population areas, such as rare skin color or rare diseases.

The category 208 of the sample 402 generated by the machine learning model can then be saved to memory, output to an output device such as a display, and/or sent to another device. In some examples, the category 208 is sent or output to a clinician for further review and/or verification.

In an example, the sample is received from a video conference software application, for example for teledermatology.

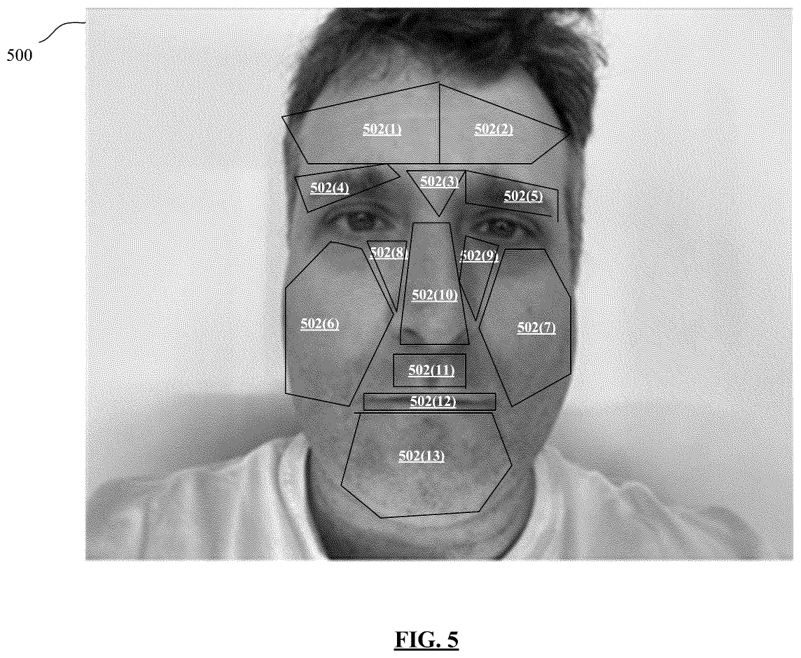

An example of segmentation by the now-trained machine learning model 204 is now discussed in greater detail with reference to FIG. 5. For example, segmentation can be performed by a segmentation module (not shown here). FIG. 5 shows that the received sample is a dermatological image 500 where at least one morphological segmentation is performed. The machine learning model 204 performs the at least one morphological segmentation of a face of the dermatological image. For example, a plurality of morphological segments 502(1)-502(13) are generated (individually referred to as morphological segment 502 or collectively morphological segments 502). As shown in FIG. 5, the plurality of morphological segments 502 includes left forehead 502(1) and right forehead 502(2), glabella 502(3), left eyebrow 502(4) and right eyebrow 502(5), left cheek 502(6) and right cheek 502(7), left perinasal fold 502(8), right perinasal fold 502(9), nose 502(10), philtrum 502(11), lips 502(12), and chin 502(13). In some examples, when the machine learning model 204 is being trained, the dataset received by the machine learning model 204 includes a plurality of dermatological images. Each dermatological image may be identified with labelled morphological segments (using lines or masks), and each morphological segment may be respectively labelled with a respective positive label or a respective negative label. For example, one dermatological image received by the machine learning model 204 includes a positive label “rosacea” associated with right cheek, and a negative label “not rosacea” associated with right cheek. Such dermatological image including the positive label “rosacea” and the negative label “not rosacea” is input to the machine learning model 204 to train the machine learning model 204.

During inference, the machine learning model 204 may receive a sample 402 (dermatological image) and generate a category 208 (perform classification) of each segment of the dermatological image. For example, during inference, after the machine learning model 204 performs segmentation of the dermatological image 500, the plurality of morphological segments 502 are generated. In addition, categorization (classification) will be then performed by the category classification module 206 on each morphological segment 502. Thus, the output of the machine learning model 204 is a respective category 208 associated with different respective morphological segment. For example, the output of machine learning model 204 includes the right cheek 502(7) of the dermatological image 500 belongs to the first category 2062 (e.g., defining a right cheek associated with “rosacea”), the left cheek 502(6) of the dermatological image 500 belongs to the first category 2062 (e.g., defining a left cheek associated with “rosacea”), and the right forehead 502(2) of the dermatological image 500 belongs to the second category 2064 (e.g., defining a right forehead associated with “not rosacea”). In this case, each category 206 is generated to be associated with a different respective morphological segment (e.g., left forehead, right forehead, glabella, etc.), rather than associated with a dermatological image.

In an example, the particular segment(s) having the first category 2062 (positive label) are generated and identified by the machine learning model 204. Similarly, the particular segment(s) having the second category 2064 (negative label) are generated and identified by the machine learning model 204. In an example, if any one segment of the patient is generated and identified as being the positive label, the entire patient is deemed (classified or inferred) by the machine learning model 204 as having the positive label. Continuing the example, particular segment(s) can be categorized by the machine learning model 204 as being the third category 2066 (outside a distribution) or the fourth category 2068 (ambiguous).

In some examples, the method 300 performed by the machine learning model 204 may be used to evaluate decisions made by a clinician. For examples, if a decision with respect to a sample 402 made by a clinician is different than an output generated by the machine learning model 204 that is input with the sample 402, the sample 402 may be re-evaluated by the clinician or another clinician. In the case where it is determined by the machine learning model 204 that the sample 402 is outside a distribution, the sample 402 will be added in the dataset to retrain the machine learning model 204. In some examples, if a first decision with respect to a sample 402 made by a first clinician disagrees with decisions (e.g., second decision, third decision, etc.) with respect to the sample 402 made by other clinicians (e.g., second clinician, third clinician, etc.), it may be concluded that the decisions with respect to the sample 402 are potentially unsafe. Thus, the sample 402 can be input to the machine learning model 204 for additional classification in order to re-evaluate the sample 402.

In other examples, samples which a clinician made decisions on (e.g. labels) may be added into the dataset 202 for training the machine learning model 204, in order to ensure that outputs (e.g. categories 208) generated by the machine learning model 204 are consistent with the decisions (e.g. labels) made by that clinician.

In some examples, the method 300 performed by the machine learning model 204 may be used as a yield management and triage safety tool. Another example pair of positive labels versus negative labels includes sources (e.g. medical images such as dermatological images) labelled with “further testing required” (e.g. biopsy) versus “no further testing required” (e.g. no biopsy). If, for example, the sample 402 (image) is classified by the method 300 and clinicians are evenly split on whether or not the sample 402 is likely to require biopsy, the conclusion may be to send the patient to a clinician for biopsy as the safest next step. Alternatively, the conclusion may be to not perform biopsy if it is the more systematic decision (e.g. financial factors, and/or or other factors for consideration). For example, the conclusion may be to not perform biopsy if it is the more financially responsible decision.

Another example pair of positive labels versus negative labels includes sources (e.g. medical images such as dermatological images) labelled with “likely treatment” (e.g. use steroid) versus “no treatment required” (e.g. don't use steroid). In some examples, the positive label of likely treatment is generated without requiring any interim diagnosis. Rather, the treatment may be known to remedy the particular appearance on the skin without requiring a specific diagnosis.

Another example pair of positive labels versus negative labels includes sources (e.g. medical images such as dermatological images) labelled with “good quality” (i.e., good enough to make a diagnosis) or “bad quality” (i.e., not good enough to make a diagnosis). For example, the label is whether the medical image is good for diagnosis. A positive label can be “good quality”, and a negative label can be “bad quality”. A consultation request should have at least one good quality image for the purpose of determining the morphology of a skin eruption. Accordingly, valuable time and resources can be saved as bad quality images are not sent or shown to the radiologist.

Another example positive label is Seborrheic dermatitis which is pink-red erythema and greasy scale in the nasolabial folds and eyebrows. In an example, referring to FIG. 5, the morphological segmentation of the face of the dermatological image into the plurality of morphological segments 502(1)-502(13) can be used to assess particular morphological segments 502(1)-502(13) for the machine learning model 204 to generate a conclusion of Seborrheic dermatitis versus not Seborrheic dermatitis.

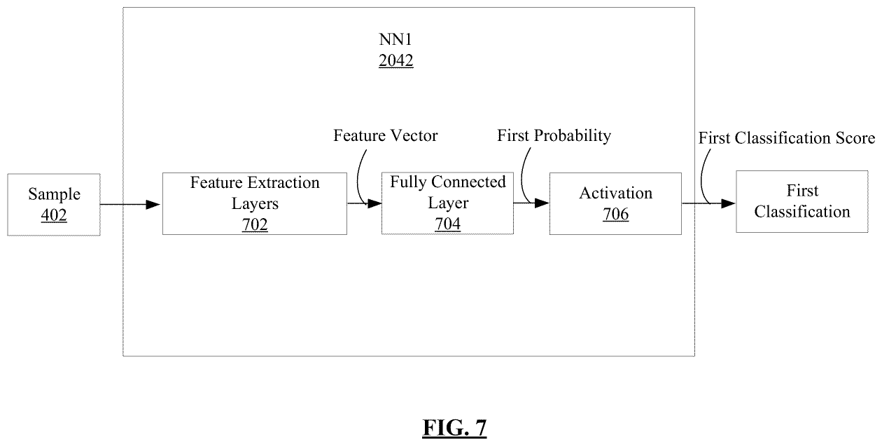

FIG. 7 shows another example embodiment of the first neural network 2042 of the machine learning model 204. For example, the first neural network 2042 can include a convolution neural network. The first neural network 2042 can receive a sample 402 and generate the first classification. In some examples, not shown here, a segmentation module is configured to segment the sample 402 into morphological segments. The feature extraction layers 702 receive the sample 402 (or morphological segments of the sample 402 as applicable) and generate a feature vector. A fully connected layer 704 uses the feature vector and generates the first probability of the positive label and the negative label. An activation module 706 uses the first probability and generates a first classification score of the positive label versus the negative label. The first classification score is used to generate the first classification, which is the positive label (when the first classification score is greater than 0.5) versus the negative label (when the first classification score is less than 0.5).

The feature extraction layers 702 can include convolution layers, pooling layers, and other layers. The feature extraction layers 702 generate a feature vector from the sample. In an example, the feature extraction layers 702 can generate feature maps (not shown here), and generate the feature vector from the feature maps.

The fully connected layer 704, which can also be called a dense layer, can be a fully connected neural network. The fully connected layer 704 can generate a first probability from the feature vector. The first probability can include a probability of the positive label and a probability of the negative label. The first probability may not be normalized at this stage in some examples.

The activation module 706 includes an activation function which normalizes the first probability into a first classification score. Examples of the activation module 706 include Softmax and sigmoid, as understood in the art. When the first classification score is greater than a threshold (0.5), the activation module 706 generates a first classification of being the positive label. When the first classification score is less than the threshold (0.5), the activation module 706 generates a first classification of being the negative label.

The second neural network 2044 can have similar features and configuration as the first neural network 2042 illustrated in FIG. 7. The second neural network 2044 generates, from the sample 402, the second classification which is the negative label (e.g. second classification score greater than 0.5 threshold) versus not the negative label (e.g. second classification score less than 0.5 threshold).

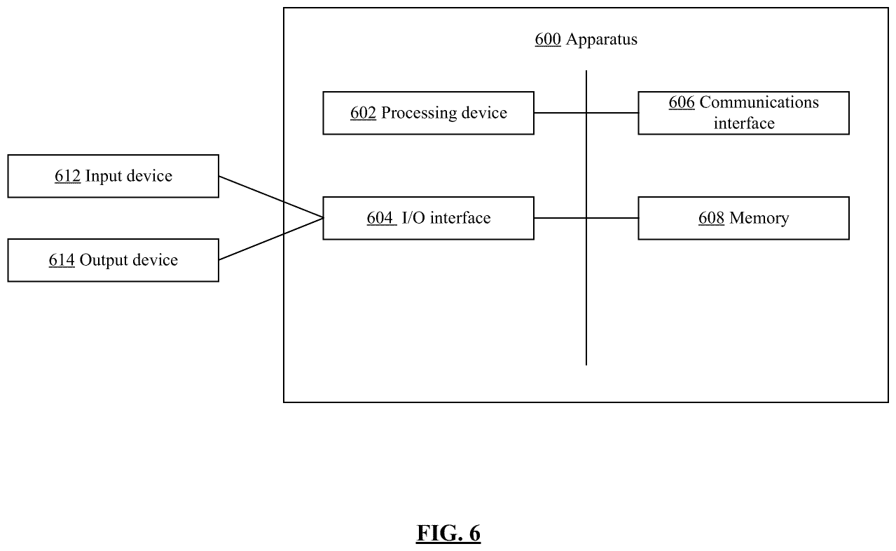

FIG. 6 illustrates an example schematic diagram showing an apparatus 600 for training and/or using (e.g., inference) example embodiments of the machine learning model 204, in accordance with an example embodiment. In examples, the apparatus 600 is a processing system in which example embodiments of the methods 100, 300 can be implemented. Other apparatuses suitable for implementing the example embodiments may be used, which may include components different from those discussed below. Although FIG. 6 shows a single instance of each component, there may be multiple instances of each component in the apparatus 600. In examples, the apparatus 600 is a computer device which may be a user equipment (UE), personal computer, a server which can be a cloud server, or a network device.

The apparatus 600 includes at least one processing device 602, such as a processor, a microprocessor, an application-specific integrated circuit (ASIC), a field-programmable gate array (FPGA), a dedicated logic circuitry, or combinations thereof The apparatus 600 may also include at least one input/output (I/O) interface 604, which may enable interfacing with one or more optional input device(s) 612 and/or output device(s) 614. In FIG. 6, the input device(s) 612 (e.g., a keyboard, a mouse, a microphone, a touchscreen, and/or a keypad) and output device(s) 614 (e.g., a display, a speaker and/or a printer) are shown as external to the apparatus 600. In other examples, one or more of the input device(s) 612 and/or the output device(s) 614 may be included as a component of the apparatus 600. In other examples, there may not be any input device(s) 612 and output device(s) 614, in which case the I/O interface 604 may not be needed.

The apparatus 600 includes at least one communications interface 606 supporting at least wireless communications over a wireless link. The apparatus 600 includes one or more antennas (not shown here).

The apparatus 600 includes at least one memory 608, which may include a volatile or non-volatile memory (e.g., a flash memory, a random access memory (RAM), and/or a read-only memory (ROM)). The non-transitory memory 608 may store instructions (e.g., program instructions in the form of software modules) for execution by the processing device 602, such as to carry out the described methods 100, 300. The memory 608 is accessible by the processing device 602, for example by being physically coupled to the processing device 602. In some applications, the memory 608 may store algorithms used by the machine learning model 204, as discussed above. The memory 608 may include other program instructions, such as for implementing an operating system and other applications/functions. In some examples, one or more data sets and/or module(s) may be provided by an external memory (e.g., an external drive in wired or wireless communication with the apparatus 600) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

Example embodiments include certain example algorithms and calculations for implementing the examples of the methods 100, 300. However, example embodiments are not bound by any particular algorithm or calculation. Although example embodiments are described with the methods 100, 300 and processes with steps in a certain order, one or more steps of the methods 100, 300 and processes may be omitted or altered as appropriate. One or more steps may take place in an order other than that in which they are described, as appropriate.

A person of ordinary skill in the art may be aware that, in combination with the example embodiments, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the example embodiments.

It may be clearly understood by a person skilled in the art that, for the purpose of convenient and brief description, for a detailed working process of the foregoing system, apparatus 600, and unit, refer to a corresponding process in the foregoing method embodiments, and details are not described herein again.

It should be understood that the disclosed apparatus 600, systems and methods (e.g. method 100, method 300) may be implemented in other manners. The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments. In addition, functional units in the embodiments of this application may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions essentially, or the part contributing to the prior art, or some of the technical solutions may be implemented in a form of a software product. The software product is stored in a storage medium, and includes several instructions for instructing the apparatus 600 or computing device (which may be a personal computer, a server which can be a cloud server, or a network device) to perform all or some of the steps of the methods 100, 300 described in the embodiments of this application. The foregoing storage medium includes any medium that can store program code, such as a universal serial bus (USB) flash drive, a removable hard disk, a read-only memory (ROM), a random access memory (RAM), a magnetic disk, or an optical disc, among others.

The foregoing descriptions are merely specific implementations of this application, but are not intended to limit the protection scope of the example embodiments. Any variation or replacement readily figured out by a person skilled in the art within the technical scope of the example embodiments.

All statements herein reciting principles, aspects, and implementations of example embodiments, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of example embodiments. Similarly, it will be appreciated that any flowcharts, flow diagrams, state transition diagrams, pseudo-code, and the like represent various processes which may be substantially represented in computer-readable instructions (program instructions). These computer-readable instructions may be provided to a processor or other programmable data processing apparatus to produce a machine, such that the instructions, which execute via the processor of the computer or other programmable data processing apparatus, create means for implementing the functions/acts specified in the flowchart and/or block diagram block or blocks. These computer-readable instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowcharts, flow diagrams, state transition diagrams, pseudo-code, and the like.

The computer-readable instructions may also be loaded onto a computer, other programmable data processing apparatus or other devices to cause a series of operational steps to be performed on the computer, other programmable apparatus or other devices to produce a computer-implemented process, such that the instructions which execute on the computer, other programmable apparatus, or other device implement the functions/acts specified in the flowcharts, flow diagrams, state transition diagrams, pseudo-code, and the like.

In some alternative implementations, the functions noted in flowcharts, flow diagrams, state transition diagrams, pseudo-code, and the like may occur out of the order noted in the figures. For example, two blocks shown in succession in a flowchart may, in fact, be executed substantially concurrently, or the blocks may sometimes be executed in the reverse order, depending upon the functionality involved. It will also be noted that each of the functions noted in the figures, and combinations of such functions can be implemented by special-purpose hardware-based systems that perform the specified functions or acts or by combinations of special-purpose hardware and computer instructions.

It will be understood that, although the terms first, second, third, etc. may be used herein to describe various elements, these elements should not be limited by these terms. These terms are used to distinguish one element from another. Thus, a first element discussed below could be termed a second element without departing from the teachings of example embodiments. As used herein, the term “and/or” includes any and all combinations of one or more of the associated listed items.

It will be understood that when an element is referred to as being “connected” or “coupled” to another element, it can be directly connected or coupled to the other element, or intervening elements may be present (e.g., indirect connection or coupling). By contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). Additionally, it will be understood that elements may be “coupled” or “connected” mechanically, electrically, communicatively, wirelessly, optically, and so on, depending on the type and nature of the elements that are being coupled or connected.

The terminology used herein is only intended to describe particular representative embodiments and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Software modules, or simply modules or units which are implied to be software, may be represented herein as any combination of flowchart elements or other elements indicating the performance of process steps and/or textual description. Such modules may be executed by hardware that is expressly or implicitly shown. Moreover, it should be understood that a module may include, for example, but without limitation, computer program logic, computer program instructions, software, stack, firmware, hardware circuitry, or a combination thereof, which provides the required capabilities. It will further be understood that a “module” generally defines a logical grouping or organization of related software code or other elements as discussed above, associated with a defined function. Thus, one of ordinary skill in the relevant arts will understand that particular code or elements that are described as being part of a “module” may be placed in other modules in some implementations, depending on the logical organization of the software code or other elements, and that such modifications are within the scope of the example embodiments.

As used herein, the term “determine” generally means to make a direct or indirect calculation, computation, decision, finding, measurement, inference, classification, categorization, conclusion, or detection. In some cases, such a determination may be approximate. Thus, determining a value indicates that the value or an approximation of the value is directly or indirectly calculated, computed, decided upon, found, measured, detected, etc.

It will be understood that, although the embodiments presented herein have been described with reference to specific features and structures, various modifications and combinations may be made. The specification and drawings are, accordingly, to be regarded simply as an illustration of the discussed implementations or embodiments and their principles as defined by the appended claims, and are contemplated to cover any and all modifications, variations, combinations or equivalents that fall within the scope of example embodiments.

1. A method of classifying, comprising:
receiving a sample;
generating, by a first neural network using the sample: a first classification of a positive label versus a negative label;
generating, by a second neural network using the sample: a second classification of the negative label versus not the negative label; and
generating, by a category classification module using the first classification and the second classification: a category of the sample.

2. The method as claimed in claim 1, wherein, when the first classification is the positive label and the second classification is not the negative label, the category of the sample by the category classification module is the positive label.

3. The method as claimed in claim 1, wherein, when the first classification is the negative label and the second classification is the negative label, the category of the sample by the category classification module is the negative label.

4. The method as claimed in claim 1, wherein, when the first classification is the negative label and the second classification is not the negative label, the category of the sample by the category classification module is outside a distribution.

5. The method as claimed in claim 1, wherein, when the first classification is the positive label and the second classification is the negative label, the category of the sample by the category classification module is ambiguous.

6. The method as claimed in claim 1, further comprising the first neural network generating a first classification score of the positive label versus the negative label, and the second neural network generating a second classification score of the negative label versus the not the negative label.

7. The method as claimed in claim 6, wherein the generating the category includes the category classification module determining that the first classification score is a probability complement to the second classification score, or within a threshold.

8. The method as claimed in claim 1, wherein the first neural network and the second neural network are in parallel.

9. The method as claimed in claim 1, wherein the category classification module is rules based.

10. The method as claimed in claim 1, wherein the category classification module is a machine learning model.

11. The method as claimed in claim 1, wherein the first neural network and the second neural network each comprise at least one of: a support vector machine (SVM), linear regression, or a convolutional neural network (CNN).

12. The method as claimed in claim 1, wherein the sample includes a medical image.

13. The method as claimed in claim 12, wherein the medical image is a dermatological image.

14. The method as claimed in claim 13, wherein the positive label is a diagnosis, a likely diagnosis, suitability for diagnosis, testing being required, or a recommended treatment.

15. The method as claimed in claim 1, further comprising:
performing, by a machine learning model, segmentation of the sample to identify morphological segments in the sample, wherein the category is generated for at least one of the morphological segments.

16. The method as claimed in claim 15, wherein the category is generated for all of the morphological segments.

17. The method as claimed in claim 1, wherein the method is performed by a processing device.

18. The method as claimed in claim 1, further comprising receiving the sample from a video conference software application.

19. A method for a machine learning model including a first neural network and a second neural network, the method comprising:
receiving a dataset comprising a first set of samples each having a positive label and a second set of samples each having a negative label;
training the first neural network using the first set of samples and the second set of samples to perform a first classification of the positive label versus the negative label;
training the second neural network using the first set of samples and the second set of samples to perform a second classification of the negative label versus not the negative label; and
providing a category classification module which is configured to generate a category using the first classification and the second classification.

20. The method as claimed in claim 19, wherein, when the first classification is the positive label and the second classification is not the negative label, the category classification module is configured to generate the category as being the positive label.

21. The method as claimed in claim 19, wherein, when the first classification is the negative label and the second classification is the negative label, the category classification module is configured to generate the category as being the negative label.

22. The method as claimed in claim 19, wherein, when the first classification is the negative label and the second classification is not the negative label, the category classification module is configured to generate the category as being outside a distribution.

23. The method as claimed in claim 19, wherein, when the first classification is the positive label and the second classification is the negative label, the category classification module is configured to generate the category as being ambiguous.

24. The method as claimed in claim 19, wherein the first neural network is configured to generate a first classification score of the positive label versus the negative label, and the second neural network is configured to generate a second classification score of the negative label versus the not the negative label.

25. The method as claimed in claim 24, wherein the category classification module is configured to generate the category by determining that the first classification score is a probability complement to the second classification score, or within a threshold.

26. The method as claimed in claim 19, wherein the first neural network and the second neural network are in parallel.

27. The method as claimed in claim 19, wherein a first number of the first set of samples is at least ten times less than a second number of the second set of samples.

28. The method as claimed in claim 19, wherein the category classification module is rules based.

29. The method as claimed in claim 19, further comprising training the category classification module to generate the category using the first classification and the second classification.

30. The method as claimed in claim 19, wherein the machine learning model comprises at least one of: a support vector machine (SVM), linear regression, or a convolutional neural network (CNN).

31. The method as claimed in claim 19, wherein the dataset includes medical images.

32. The method as claimed in claim 31, wherein the medical images are dermatological images.

33. The method as claimed in claim 32, wherein each of the dermatological images are labelled with a diagnosis, a likely diagnosis, suitability for diagnosis, testing being required, or a recommended treatment.

34. The method as claimed in claim 19, the method further comprising:
training the machine learning model to perform segmentation to identify morphological segments, wherein the category classification module is configured to generate the category of at least one of the morphological segments.

35. The method as claimed in claim 34, wherein the category classification module is configured to generate the category of all of the morphological segments.

36. The method as claimed in claim 19, wherein the method is performed by a processing device.

37. A system for training a machine learning model including a first neural network and a second neural network, the system comprising:
a processing device; and
a memory accessible by the processing device, the memory storing machine-executable instructions that, when executed by the processing device, cause the processing device to:
receive a dataset comprising a first set of samples each having a positive label and a second set of samples each having a negative label;
train the first neural network using the first set of samples and the second set of samples to perform a first classification of the positive label versus the negative label;
train the second neural network using the first set of samples and the second set of samples to perform a second classification of the negative label versus not the negative label; and
provide a category classification module which is configured to generate a category using the first classification and the second classification.

38. A non-transient computer readable medium containing instructions for causing a processing device to perform a method for a machine learning model including a first neural network and a second neural network, the instructions comprising:
instructions for receiving a dataset comprising a first set of samples each having a positive label and a second set of samples each having a negative label;
instructions for training the first neural network using the first set of samples and the second set of samples to perform a first classification of the positive label versus the negative label;
instructions for training the second neural network using the first set of samples and the second set of samples to perform a second classification of the negative label versus not the negative label; and
instructions for providing a category classification module which is configured to generate a category using the first classification and the second classification.

39. A system for classifying, the system comprising:
a processing device; and
a memory accessible by the processing device, the memory storing machine-executable instructions that, when executed by the processing device, cause the processing device to:
receive a sample;
generate, by a first neural network using the sample: a first classification of a positive label versus a negative label;
generate, by a second neural network using the sample: a second classification of the negative label versus not the negative label; and
generate, by a category classification module using the first classification and the second classification: a category of the sample.

40. A non-transient computer readable medium containing instructions for causing a processing device to perform a method, the instructions comprising:
instructions for receiving a sample;
instructions for generating, by a first neural network using the sample: a first classification of a positive label versus a negative label;
instructions for generating, by a second neural network using the sample: a second classification of the negative label versus not the negative label; and
instructions for using the first classification and the second classification to generate a category of the sample.
